(19) United States
(12) Patent Application Publication
(10) Pub. No.: US 2008/0133311 A1
(43) Pub. Date: Jun. 5, 2008

(54) SYSTEM AND METHOD FOR MANAGING CONTENT CONSUMPTION USING A CONTENT LICENSING PLATFORM

(76) Inventor: Rodrigo Dario Madriz Ottolina, Toronto (CA)

Correspondence Address: PILLSBURY WINTHROP SHAW PITTMAN, LLP, P.O. BOX 10500, MCLEAN, VA, 22102, US

(21) Appl. No.: 11/565,787

(22) Filed: Dec. 1, 2006

(51) Int. Cl. G06Q 30/00

(52) U.S. Cl. 705/10; 705/14

(57) ABSTRACT

A centralized content management system is provided. The system may balance interests among content creators, content owners, advertisers, consumers, and/or others in a content transaction chain. Media, advertising, or other types of content may have a content licensing platform embedded therein. The platform may enable a centralized clearinghouse to automatically monitor consumption of various types of content. Accordingly, the clearinghouse may use the monitored information to pay owners of consumed media content, invoice sponsors of consumed advertising content, build consumer profiles, or other things. Furthermore, content asset transaction value may be maximized throughout the chain, as content creators may establish prices for their content, advertisers may compete for ad-insertion, and consumers may establish a desired price for content using a variable pricing scheme.

### FIELD OF THE INVENTION

The present invention relates to managing content transactions based on consumption, and in particular, to an automated system for validating content consumption and collecting royalties in an on-demand, advertising supported environment.

### BACKGROUND OF THE INVENTION

In traditional media broadcasting systems, each consumer receives identical repertoires of content and advertising. Each individual tuned in to a particular broadcast, channel, or station would receive the same content, and the same advertisements, regardless of differences in demographics or other characteristics. As a result, media buyers (e.g., advertisers) would make purchasing decisions (e.g., buy advertising time) based on aggregate audience models, such as those provided by Nielsen Ratings. While services such as Nielsen claim to provide statistically significant measures of consumer segmentation based on demographics, such services are simply unable to keep pace with increasing fragmentation in the digital age.

As broadband network access (both wired and wireless) grows in scale, quality, and availability, a new generation of Internet applications has emerged. One area experiencing remarkable growth in the Internet space is the market for on-demand rich media, which has fundamentally altered the platform for media broadcasting. As a result, opportunities have been created for increasingly disruptive business models in the marketplace. For example, as on-demand rich media expands, a more fragmented world becomes apparent. In an on-demand environment, each individual consumes a unique content repertoire, and thus existing media buying models are inadequate for advertisers. Pragmatically speaking, advertisers care most about whether a likely buyer of their products or services is likely to be reached through a particular medium. Existing systems are unable to exploit technology in a way to enable advertisers to reach and engage a specific target audience on a one-to-one basis.

Correlatively, the paradigm shift in network platforms has led to increased exposure, and new forums, for creative expression. More than ever, creators of audio and video content are able to deliver content to the masses. However, managing rights over digitally created content is particularly troublesome, and techniques for effectively generating royalties and other revenue for artists have been elusive. Existing systems are unable to provide artists, authors, and other content creators with an automatic, verifiable, and tangible financial benefit from consumption of their content. For example, an independent content creator who posts work on the Internet may have their content become incredibly popular, and widely consumed. However, the creators of such content are rarely, if ever, able to automatically and reliably collect royalties or other payments by exploiting an on-demand, advertising-supported, content consumption platform. Furthermore, existing systems do not support royalty collection that is neutral to where consumption occurs. Similarly, existing systems do not allow content owners, such as record labels, to effectively leverage technology to protect rights over digitally distributed content, or sell advertising time based on a highest bidder for a particular audience impression.

Existing systems are unable to strike the proper balance between protecting the rights of content creators, while generating effective audience advertising impressions, without undermining consumer expectations. For example, as broadband Internet access has become more prevalent, many consumers use peer-to-peer software or other file sharing techniques to receive content for free. However, this undermines the rights of content creators, and frustrates the goals of advertisers who want to reach those consumers. Even when consumers are willing to pay for content, artists, labels, movie studios, or other content producers have to negotiate independent agreements with the various platforms that deliver licensed content to consumers. Furthermore, on-demand markets are widely fragmented, and consumers may use a variety of content delivery platforms, but existing systems do not provide solutions for delivering licensed content in a platform-independent manner.

Despite the stigma of illegality surrounding peer-to-peer file sharing, significant economic incentives exist for content distributors to adopt peer-to-peer content distribution. For example, peer-to-peer distribution removes infrastructure burdens, such as supporting a large number of simultaneous client connections without compromising server bandwidth guarantees. In this sense, peer-to-peer distribution is very cost-effective, as Internet Service Providers alleviate infrastructure requirements through their “best efforts” conditions of service. However, existing peer-to-peer systems (e.g., BitTorrent, Kazaa, etc.) fail to include mechanisms that recognize rights of content owners, making them fertile grounds for free circulation of pirated content, without compensating rights owners when content is consumed.

Furthermore, existing systems fail to account for the dichotomy where some consumers may be willing to pay for content, while others may only want the content for free. In other words, some consumers may be willing to pay a premium to receive advertisement-free content, while others may prefer to receive advertisements in exchange for free content, while still others may fall somewhere in between. However, existing systems fail to respond to consumer preferences in a way that generates an optimal amount of revenue for content creators, regardless of the consumer's willingness to pay.

Therefore, existing systems are unable to manage content in a way that maximizes value throughout a distribution chain. Existing suffer from these and other problems.

### SUMMARY OF THE INVENTION

According to various aspects and implementations of the invention, a system and method for centralized management of content may address the drawbacks of existing systems by maintaining relationships, and balancing interests, among content creators, advertisers, consumers, and/or others in a content transaction chain, thereby maximizing content asset transaction values for each party in the chain.

According to various aspects of the invention, a centralized content management system may account for unique needs of each party in a distribution chain. Artists, content producers, advertisers, or others may create content embedded with a content licensing platform. As used herein, “content” may refer to media content, advertising content, or any other type of content, as would be apparent to those skilled in the art. For example, a content asset transaction may include an end user downloading media content (e.g., songs, podcasts, etc.) from a distribution service (e.g., iTunes, SpiralFrog, etc.), wherein the downloaded media content may be supported by advertising content (e.g., an audio advertisement may be dynamically inserted into an audio podcast). Accordingly, content asset transactions may include various types of dynamic content (e.g., media content supported by advertising content).

According to various aspects of the invention, the content licensing platform may enable automatic tagging, tracking, validating, auditing, and other processing of content asset transactions. For example, a centralized clearinghouse may automatically monitor consumption of various types of content via a backchannel enabled by the content licensing platform. Accordingly, information about consumption may be used, for example, to pay owners of consumed media content, invoice sponsors of consumed advertising content, build consumer profiles, and/or many other things. The content licensing platform may also enable maximizing revenue generated from a content asset transaction. For example, advertisements may be dynamically inserted into various types of content based on criteria provided by content owners, advertisers, consumers, and/or others. Content owners may establish pricing schemes when creating content (e.g., media content), and advertisers may compete to have advertising content inserted into content units and/or pre-determined playlists. By having advertisers compete for media consumption time, advertisements may be inserted into content based on which advertiser most values a particular audience impression. Further, advertisements inserted into content may be updated (e.g., by selecting a new advertisement from an inventory) when content changes hands (e.g., via a peer-to-peer transfer), is played, or when other business rules trigger replenishing and/or renewing advertisements inserted within content. Accordingly, utilizing a broad range of advertisements in an inventory may maximize revenue generated from advertisement insertion.

According to some aspects of the invention, the clearinghouse may satisfy consumer expectations by, among other things, providing access to content from an unlimited range of artists, content producers, distributors, and/or others, while also implementing a variable pricing scheme to enable users to set a desired price to access content. Furthermore, consumers may access content created using the content licensing platform regardless of an origin of the content. For example, consumers may receive content from a distributor of their choice, from other consumers using different distributors (e.g., in a peer-to-peer environment), or from other origins. Consumers may use media players that comply with the content licensing platform, enabling a free flow of content among participants in a content ecosystem. For example, entities associated with content created using the content licensing platform may be uniquely identified by information embedded within the content, enabling tracking of consumption to ensure proper compensation for each entity's contribution to distributing the content. Those skilled in the art will recognize many additional uses, benefits, and advantages of the invention.

According to various aspects of the invention, a centralized content management system may include, among other things, a centralized clearinghouse for maintaining relationships between artists, content producers, distributors, advertisers, consumers, and/or other entities in a content asset transaction chain. The centralized clearinghouse may act as an arbitrator, or validator, among the various entities in the chain. For example, artists, content producers, advertisers, distributors, and/or others may register with the clearinghouse, and a unique identifier may be assigned to each entity. Furthermore, the clearinghouse may provide various tools for the entities to create content, submit profiles, access transaction data, or otherwise interact with the clearinghouse. Moreover, created content may have a content licensing platform embedded therein, wherein information about each entity associated with the created content may be included therein (e.g., via a rich codec metadata). The content licensing platform may provide a backchannel to the clearinghouse, such that the clearinghouse may track, validate, and audit consumption of content. In some implementations, the clearinghouse may receive consumer profiles (e.g., from a third-party consumer information provider). Accordingly, advertisements may be dynamically inserted into content based on a target audience, as well as pricing preferences of various entities in the chain, thereby maximizing value for a content asset transaction throughout the chain.

Other objects and advantages of the invention will be apparent to those skilled in the art based on the following drawings and detailed description.

### BRIEF DESCRIPTION OF THE DRAWINGS

FIG. 1 illustrates an exemplary content management system according to various aspects of the invention.

FIG. 2 illustrates an exemplary content delivery model according to various aspects of the invention.

FIGS. 3a-d illustrate exemplary data flow among entities in a content asset transaction chain according to various aspects of the invention.

FIGS. 4a-b illustrate exemplary states of content created according to various aspects of the invention.

FIG. 5 illustrates an exemplary content asset transaction chain according to various aspects of the invention.

### DETAILED DESCRIPTION

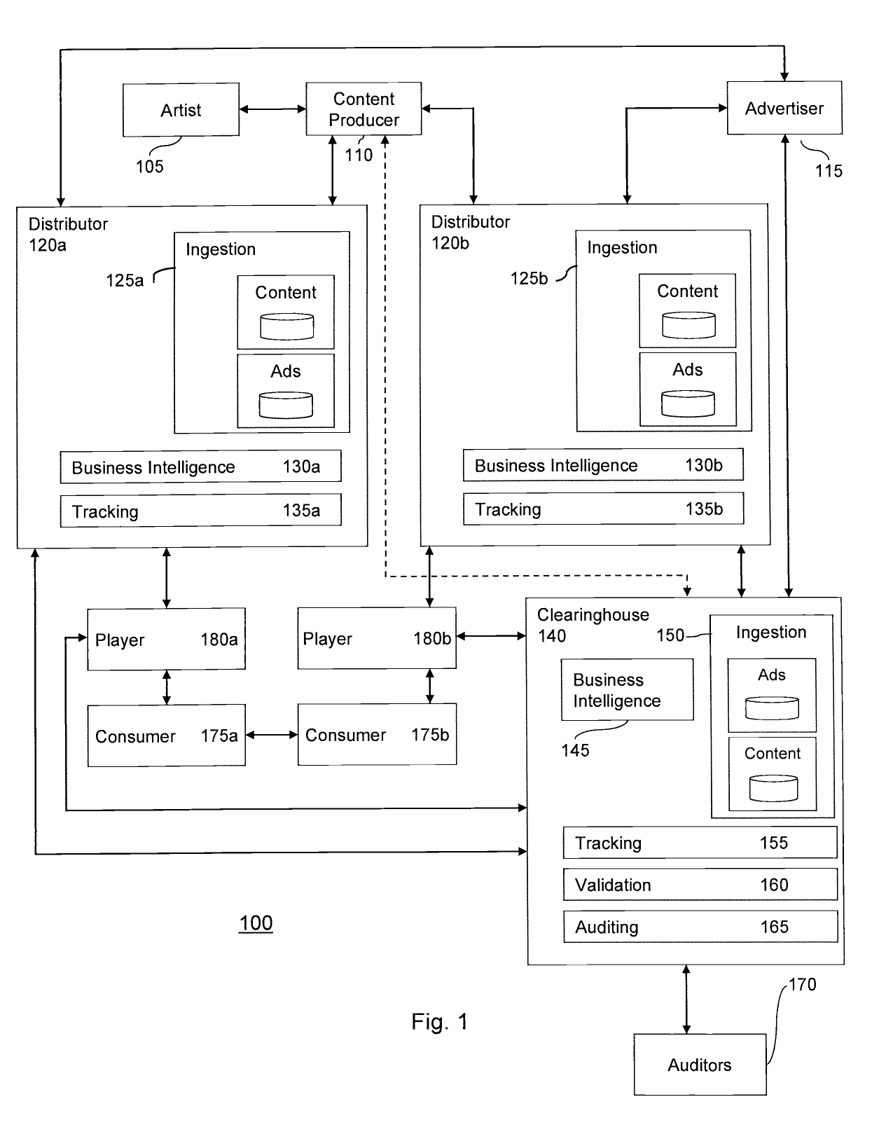

Referring to FIG. 1, an exemplary content management system 100 is provided according to various aspects of the invention. System 100 may manage interactions among various entities in a content asset transaction chain in a way that maximizes content asset transaction values for each party in the chain. For example, each entity in the content asset transaction chain may assume at least one role, such as a role of an artist 105, a content producer 110, an advertiser 115, a distributor 120, a consumer 175, an auditor 170, a player 180, and/or others. Each entity may have unique needs, interests, or other characteristics, and system 100 may overcome the drawbacks of existing systems by managing content transactions in a way that furthers the interests of each entity in the chain. Those skilled in the art will recognize that in some implementations, entities may assume multiple roles, or roles may be shared among multiple entities, or various permutations thereof may be realized. For example, an artist 105 (e.g., a musician, filmmaker, etc.) may be unlabeled, independent, unsponsored, or otherwise unrepresented by a content producer 110 or distributor 120. Therefore, the artist 105 may also register with clearinghouse 140 as a content producer 110, distributor 120, or in other roles. In another example, artists 105 may maximize royalty collection resulting from content consumption by acting as their own content producer 110 and/or distributor 120, as the transaction chain may have less entities entitled to collect portions of the royalty. Many other variants are possible, and roles may be allocated in many different ways, without departing from the scope of the invention.

Content management system 100 may include a clearinghouse 140. Clearinghouse 140 may include, among other things, a business intelligence module 145, an ingestion module 150, a tracking module 155, a validation module 160, and/or an auditing module 165. In some implementations, auditing module 165 may interface with one or more auditors 170, wherein clearinghouse 140 may use a transparent data model that enables auditors 170 to view transaction data in real-time. Clearinghouse 140 may act as a centralized “hub” for managing all content and advertising in system 100, and therefore may supervise content asset transactions in system 100. For example, various entities in the content asset transaction chain may be uniquely identified by clearinghouse 140, wherein clearinghouse 140 may use the unique identifiers to arbitrate (or validate) among the various entities. To this end, clearinghouse 140 may use tracking module 155 to track content consumption, validation module 160 to arbitrate or validate among entities in the transaction chain, and auditing module 165 to generate various reports (e.g., of consumed content, inserted advertisement values, royalty values, etc.). Various entities in the transaction chain may access historical consumption data (e.g., media, advertising, or other content consumption data), advertising profiles, real-time transaction data, or other information via one or more of modules 155-165. Those skilled in the art will appreciate that the various features of functions of clearinghouse 140 may be combined or distributed in various ways, and that other uses and implementations are possible, without departing from the scope of the invention.

In some implementations, clearinghouse 140 may manage content asset transactions by providing one or more tools for various entities to interact and comply with clearinghouse 140. For example, the tools may include an application for artists 105, content producers 110, distributors 120, advertisers 115, and/or others to create content. The created content may be embedded with a content licensing platform. The content licensing platform may enable, among other things, accountability of content consumption, intra-file advertisement insertion, unique identification of entities and content in a transaction chain, advertisement interactivity, variable consumer pricing schemes, content consumption validation in peer-to-peer environments, or other features. In some implementations, the content licensing platform may be included within a codec that encodes media, advertising, or other types of content. For example, the codec may include a metadata that provides rich information about the encoded content, which may be used in various ways, including determining advertisements for insertion, monitoring content consumption, or other things.

Furthermore, clearinghouse 140 may obtain demographic information, or other profiling information, about consumers 175 (e.g., via a third party consumer information provider, or in other ways). Accordingly, business intelligence modules 130 and 145, or other modules, may correlate information about encoded content with consumer profile information to dynamically determine advertisement insertion. As various types of content are consumed (e.g., by consumers 175), tracking modules 135 and 165, validation module 160, and/or auditing module 165 may perform various tasks for accounting for the consumption, generating bills, performing various analyses, or other tasks. Accordingly, content owners (e.g., artists 105, content producers 110, distributors 120, etc.) may receive revenue from consumption of their content, advertisers 115 may obtain valuable and targeted audience impressions from consumption of their content, and consumers 175 may receive content on their own terms. Other advantages and Implementations of the invention will be apparent to those skilled in the art.

According to various aspects of the invention, an artist 105 may be an entity that creates content (e.g., via an application that embeds the content licensing platform). For example, an artist 105 may be a musician, a filmmaker, a radio broadcaster, a writer, or any other entity that creates audio, video, written, or other type of content. Artists 105 may register with clearinghouse 140 to receive a unique identifier. When artists 105 create content, each piece of created content may be imprinted or encoded with, among other things, the unique identifier for the artist 105. Artists 105 may maintain a relationship with a content producer 110, where content producer 110 may be an entity that registers content with, or releases content to, clearinghouse 140 on behalf of an artist 105. For example, content producers 110 may be record labels, production companies, publishers, radio stations, or any other entity that may register content for an artist 105. Content producers 110 may register with clearinghouse 140 to obtain a unique identifier for properly directing royalty payments, generating content ratings (e.g., popularity ratings), generating invoices, and/or for other uses. Moreover, in accordance with their role as acting on behalf of artists 105, content producers 110 may license content from artists 105, register the licensed content with clearinghouse 140, release compliant licensed content to distributors 120 and/or clearinghouse 140, and/or perform other tasks.

According to various aspects of the invention, a distributor 120 may be an entity that distributes registered content to a consumer 175. As illustrated in FIG. 1, system 100 may enable various distributors 120 (e.g., distributor 120a, 120b, etc.) to distribute advertisement-supported content to respective consumers 175a, 175b, etc. For example, distributors 120 may arrange with content producers 110 and/or artists 105 to distribute content for consumption by end-users. Artists 105 and/or content producers 110 may provide content to distributors 120 for storage in a content repository, managed by an ingestion module 125. Moreover, distributor 120 may arrange with advertisers 115 to receive advertising content for storage in an advertisement repository, managed by ingestion module 125. Thus, distributor 120 may provide resources necessary to provide consumers 175 with advertisement-supported content, which may be embedded with information to track, validate, and audit consumption in a transparent and platform-independent manner.

According to various aspects of the invention, distributor 120 may register with clearinghouse 140 to receive a unique identifier, and accordingly, distributor 120 may interact with clearinghouse 140. In some implementations, distributor 120 may include, among other things, a business intelligence module 130 and/or a tracking module 135. Business intelligence module 130 and/or tracking module 135 may communicate with clearinghouse 140 to manage the identification of the parties, tagging, matching, insertion, serving, tracking, or other tasks related to providing advertisement-supported content to consumers 175. For example, when consumers 175 receive and consume content, distributor 120 may track such consumption (e.g., using information embedded in the content), and accordingly, may provide tracking and/or validation information to clearinghouse 140. Correlatively, distributor 120 may collect preferences about consumers 175 (e.g., media, advertising, or other types of preferences), or generate profiling metrics about consumers 175, which may be relayed to clearinghouse 140. In some implementations, consumers 175 may elect not to provide detailed profile information, in which case profiling metrics about a consumer 175 may be generated in other ways (e.g., a default profile may be generated based on an Internet Protocol address of the consumer 175). As content is consumed, clearinghouse 140 and distributor 120 may cooperate to provide payments or reimbursements to artists 105, content producers 110, or other relevant entities. Similarly, as advertising is consumed, clearinghouse 140 and distributor 120 may generate bills or invoices for advertisers 115 or other relevant entities. In some implementations, clearinghouse 140 may act as a distributor 120, and may provide content from a repository directly to a consumer 175.

According to various aspects of the invention, consumers 175 may view, play, or otherwise access advertisement supported content distributed by distributors 120 and/or clearinghouse 140 via a player 180 (e.g., a media player). Advertisements may be sent to player 180 by distributors 120 and/or clearinghouse 140, and player 180 may insert the advertisements according to a minimum royalty scheme, as determined by artists 105, content producers 110, and/or others having rights to the content. In some implementations, content may be provided from a first consumer 175a to a second consumer 175b, or vice-versa (e.g., in a peer-to-peer environment) using any suitable file transfer mechanism. For example, a first consumer 175a associated with a first distributor 120a may provide content to a second consumer 175b associated with a second distributor 120b. When consumer 175b accesses the content using player 180b, player 180b may communicate with distributor 120b. Distributor 120b may use business intelligence module 130b in conjunction with clearinghouse 140 to determine advertisements to send to player 180b. Accordingly, advertisements may be sent to player 180b based on generating maximum value for an impression upon consumer 175b, even when consumer 175b receives content in peer-to-peer environments unaffiliated with system 100, provided that player 180b is compliant with system 100. In some implementations, player 180 may be a stand-alone player unaffiliated with any particular distributor 120. For example, player 180 may communicate with clearinghouse 140 to insert advertisements provided by clearinghouse 140, validate content consumption, or to perform other tasks.

According to various aspects of the invention, an advertiser 115 may be an entity that promotes products or services. For example, advertisers 115 may register with distributor 120 and/or clearinghouse 140, and may provide payments to distributor 120 and/or clearinghouse 140. In some implementations, advertisers 115 and their advertising content may be provided with a unique identifier, and may create advertising content using an application that embeds advertising content with the content licensing platform. Accordingly, advertisers 115 may create advertising content embedded with their unique identifier, as well as other information relevant to an advertising campaign. For example, advertisers 115 may specify a desired target audience. In another example, advertisers 115 may specify amounts to pay for advertisement-insertion in various circumstances. The information may be used to maximize content asset transaction values by choosing an advertisement for insertion based on which advertisement may generate a maximum amount of revenue. In some implementations, advertisers 115 may register advertising content with clearinghouse 140 and/or distributor 120, and advertisers 115 may release or provide the created advertising content to clearinghouse 140 and/or distributor 120. Accordingly, distributor 120 and/or clearinghouse 140 may match, provide, track, validate, audit, or otherwise process advertising content consumption. The consumption information may be used, for example, to generate bills or invoices for advertisers 115 (e.g., according to encoded information about an advertising campaign), or in other ways. Those skilled in the art will appreciate that other implementations, uses, benefits, or variants are possible without departing from the scope of the invention.

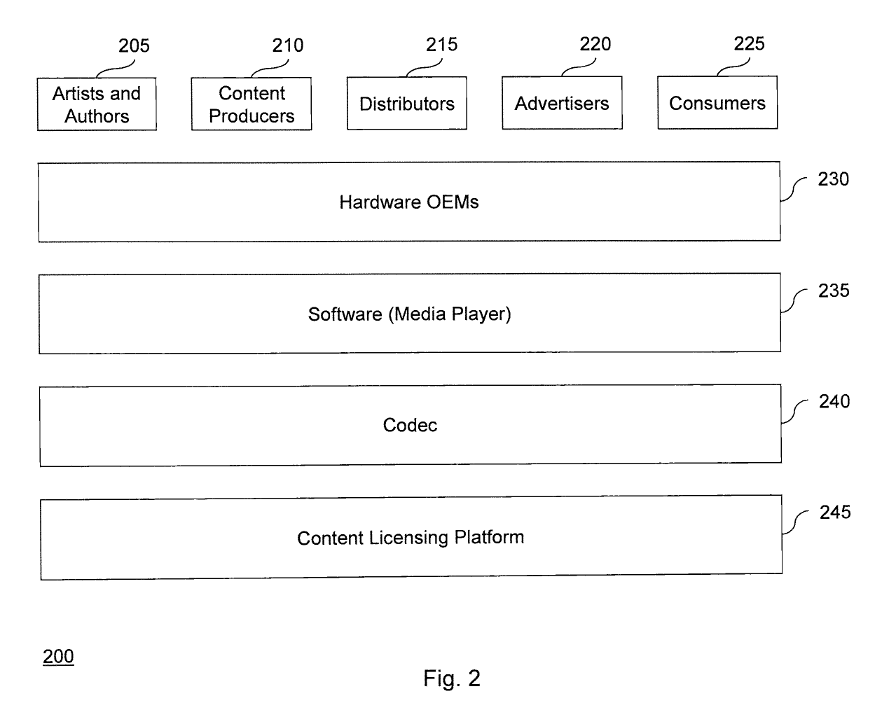

Referring to FIG. 2, an exemplary content delivery model 200 is provided according to various aspects of the invention. Content delivery model 200 may be built upon a content licensing platform 245, which may address the needs and expectations of artists and/or authors 205, content producers 210, distributors 215, advertisers 220, consumers 225, and/or others. Content delivery model 200 may be neutral to hardware original equipment manufacturers 230 and/or software platforms (e.g., media players) 235, as well as codecs 240. For example, as various entities 205-220 create content (e.g., media content, advertising content, etc.) having content licensing platform 245 embedded therein, the created content may be imprinted with at least a unique identifier for each entity. The created content may be encoded, and prepared for delivery to consumers 235, using a codec 240 that is compliant with content licensing platform 245. Hardware platforms 230 and/or media players 235 may have a built-in application, plug-in application, or other application that is compliant with content management system 100 in FIG. 1 and that automatically collects information about content and/or advertising content consumption. By embedding content licensing platform 245 within codec 240, consumers 225 may choose their hardware platforms 230 and/or media players 235, which may automatically collect information related to content consumption. The collected information may be used, for example, to report royalty payment information and/or other transaction data to content producers 210, advertisers 220, distributors 215, and/or others. In another example, the collected consumption information may be used to invoice advertisers, generate reports, build demographic profiles, or in other ways.

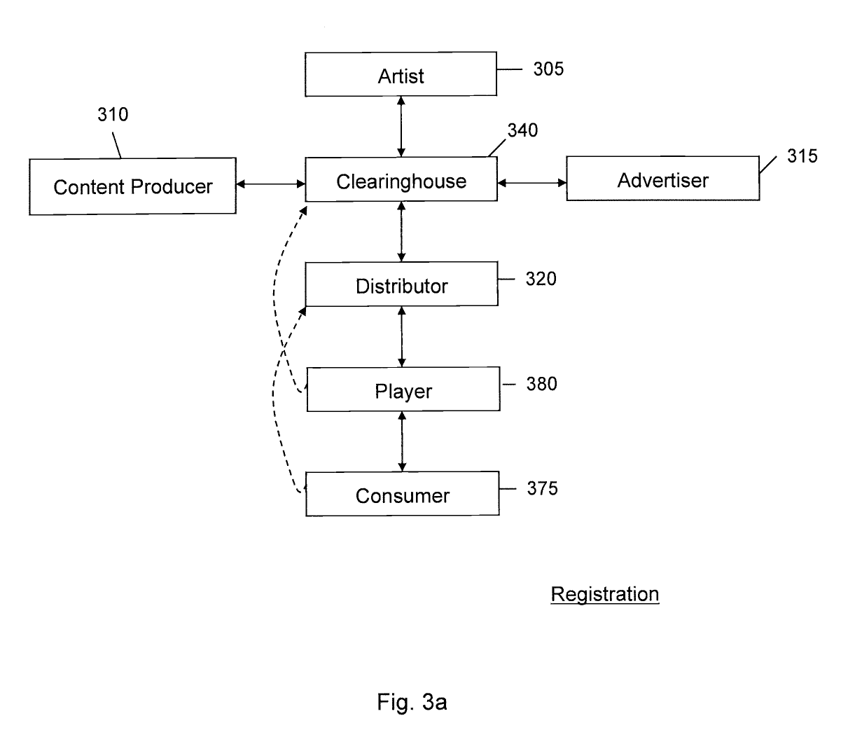

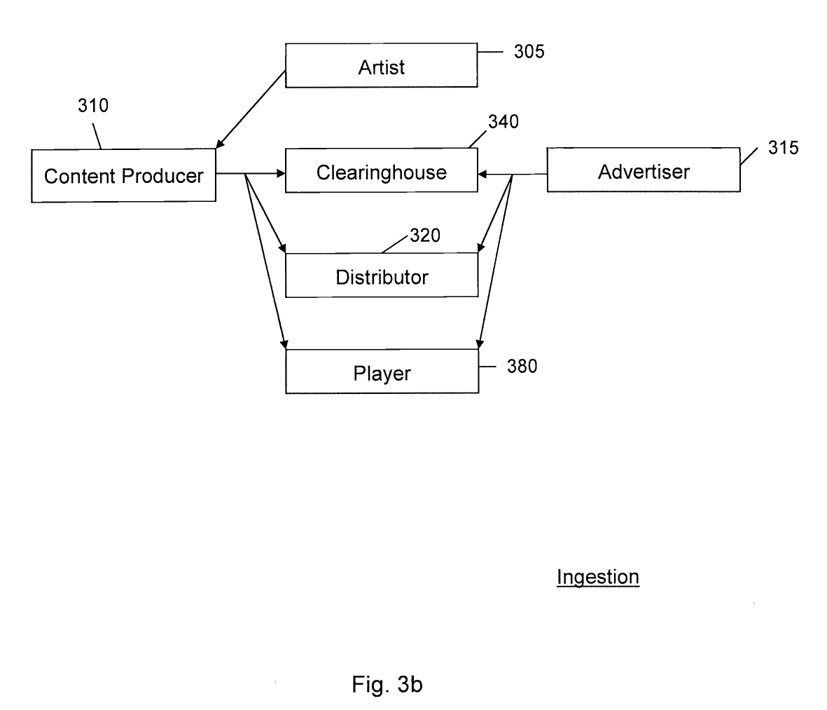

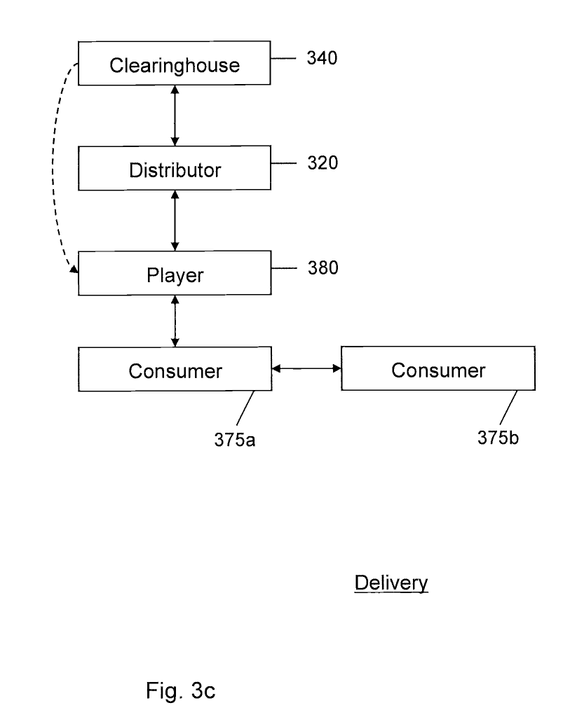

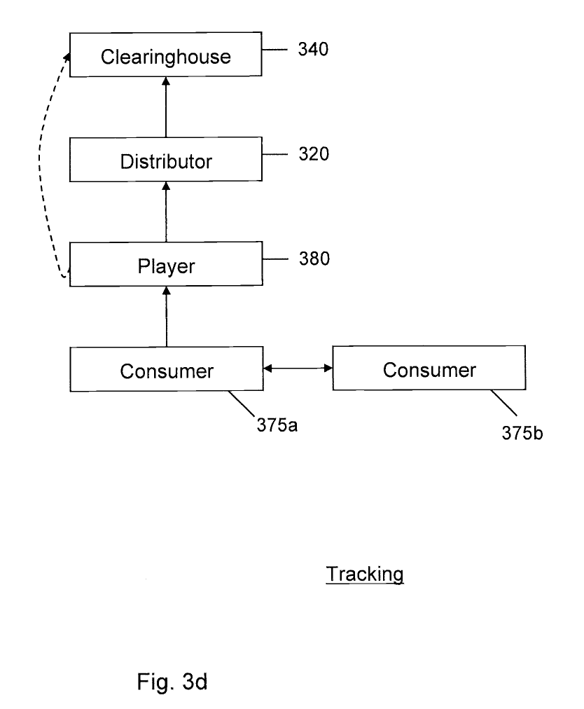

Referring to FIGS. 3a-d, exemplary data flows are provided among entities in a content asset transaction chain according to various aspects of the invention. The data flows may be based upon content delivery model 200, where content described in FIGS. 3a-d may have content licensing platform 245 automatically embedded therein. For example, content creators (e.g., artists, content producers, distributors, advertisers, or others) may use any suitable application, or combination of applications, to create content in compliance with content delivery model 200 and/or content management system 100 in FIG. 1. Accordingly, content licensing platform 245 may be automatically embedded within media, advertising, or other types of content created according to content delivery model 200. Content licensing platform 245 may enable accountability of content consumption, unique identification of entities associated with content, robust advertisement-insertion, advertisement interactivity, and/or variable pricing based on consumer preferences, among other things.

Referring to FIG. 3a, an exemplary registration data flow is provided according to various aspects of the invention. Artists 305, content producers 310, advertisers 315, distributors 320, players 380, consumers 375, and/or others may register with a clearinghouse 340. In some implementations, entities may register with clearinghouse 340 using a registration process, which may include submitting a profile to clearinghouse 340, among other things. After an entity has completed registration requirements (e.g., by submitting a profile), clearinghouse 340 may assign a unique identifier to the registering entity. Accordingly, an entity's subsequent interaction with clearinghouse 340 may be secured using at least the assigned unique identifier. Thus, unauthorized parties may be prevented from fraudulently profiting from the works of others (e.g., due to pretending authorship and/or having rights to content ingested in the system). For example, clearinghouse 340 may manage associations between content and registered entities using the unique identifiers, or other information embedded by content licensing platform 245. In another example, registered entities may use their unique identifiers to access clearinghouse 340, modify profiles, access historical or real-time transaction data, or perform other tasks related to clearinghouse 340.

Furthermore, consumers 375 may be provided with advertisement-supported content from a distributor 320 and/or player 380 of their choice, regardless of the content's origin. For example, content may be sourced (e.g., downloaded) from another consumer 375, or from any other entity in a content ecosystem, using any suitable file transfer method (e.g., peer-to-peer, streaming, etc.). As such, consumers 375 may register with a distributor 320 using any suitable registration mechanism, or consumers 375 may use a registered player 380. In some implementations, consumers 375 may provide preferences, profiles, or other information to distributor 320, player 380, and/or a third-party consumer information provider. In some implementations, consumers 375 may prefer not to provide profiling information, and clearinghouse 340, distributor 320, and/or player 380 may use default methods of building profiles based on user activity, network location information, or other information. Clearinghouse 340, distributor 320, and/or player 380 may use profile information for a given consumer 375 to match content with advertising content based on a highest bidding advertiser 315 for the given consumer 375. Therefore, as shown in FIG. 3a, clearinghouse 340 may manage relationships with artists 305, content producers 310, distributors 320, players 380, advertisers 315, and/or others, while distributors 320, and/or players 380 may manage relationships with consumers 375, thereby providing maximum flexibility over content delivery, tracking, validation, auditing, or other tasks,

Referring to FIG. 3b, an exemplary content ingestion data flow is provided according to various aspects of the invention. The content ingestion data flow may include a process whereby media content, advertising content, or other types of content may be received by a distributor 320, a player 380, and/or a clearinghouse 340. For example, artists 305, content producers 310, and/or advertisers 315 may create content, which may be embedded with content licensing platform 245. The embedded content may be ingested by distributor 320, player 380, and/or clearinghouse for further action.

Artist 305 may create content in compliance with content delivery model 200 using any suitable technique (e.g., at the discretion of artist 305, tools provided by content management system 100 in FIG. 1 may be used). For example, artist 305 may create and/or encode content using an application that embeds content licensing platform 245 within the content. As such, artist 305 may describe the content with a rich codec metadata that provides information about the content. The provided information may include a unique identifier for artist 305, an author, name, episode, and/or subject of the content, a producer of the content (e.g., a producer name and/or company), guest information (e.g., names, companies, roles, related publications, social networks, etc.), playlist information (e.g., songs played during an audio podcast), time-stamps for advertisement insertion (e.g., indicating location and/or duration of commercial breaks), user-provided ratings (e.g., user recommendations, popularity indices, age-appropriateness ratings, etc.), hyperlinks (e.g., to related sites, social networks, etc.), bandwidth streaming requirements, duration, language (e.g., English), location of content origination (e.g., zip code, city, state, etc.), access restrictions, digital rights management keys, expiration date, codes (e.g., for a University code indicating class code, name, credits, etc.), Standard Industrial Classification, North American Industry Classification, social network affiliations, or other information. Those skilled in the art will appreciate that some or all metadata fields may be used as appropriate, and that metadata fields may be added, deleted, updated, or otherwise changed without departing from the scope of the invention.

Artist 305 may provide created content to a content producer 310. Content producer 310 may encode and/or describe the content when artist 305 has not, has left fields empty, or in other circumstances. For example, content producer 310 may imprint the content metadata with the unique identifier for artist 305, as well as other information as described above, as needed. Furthermore, content producer 310 may supplement the content description by imprinting the metadata with a unique identifier for content producer 310. Content producer 310 may subsequently register the content with clearinghouse 340 (e.g., by submitting content metadata and/or content to clearinghouse 340).

When clearinghouse 340 determines that the content is compliant, and that the content producer 310 has the proper rights to ingest content into clearinghouse 340 and/or distributor 320, clearinghouse 340 may extract the metadata, register the content, and/or provide a unique identifier for the registered content to content producer 310. Content producer 310 may subsequently imprint the unique identifier for the registered content in the content metadata, and the content may ingested (e.g., stored in a repository) by distributor 320 and/or clearinghouse 340. In some implementations, the ingestion may include playing the ingested content by player 380. Accordingly, distributors 320, clearinghouse 340, and/or players 380 may receive (i.e., ingest) one or more indexed content assets, which uniquely identify artists 305, content producers 310, and/or distributors 320 associated with the indexed context assets. In some implementations, artists 305, content producers 310, distributors 320, and/or others may establish a pricing scheme when creating the indexed content assets. For example, the pricing scheme may establish a minimum price to charge advertisers 315 for ad-insertion. Accordingly, proper royalties, as established by artist 305 and/or content producer 310, may be guaranteed.

In some implementations, advertiser 315 may create advertising content in compliance with content delivery model 200 using any suitable technique. For example, advertiser 315 may create and/or encode advertising content using an application that embeds content licensing platform 245 within the content. As such, advertiser 315 may describe the advertising content with a rich codec metadata that provides information about the content. The provided information may include a unique identifier for advertiser 315, billing information for advertiser 315, a gender and/or age of a target audience, location information (e.g., zip code, city, state, etc.), professions, industries, household income, household size, marital status, social network affiliations, and/or other information. Those skilled in the art will appreciate that some or all metadata fields may be used as appropriate, and that metadata fields may be added, deleted, updated, or otherwise changed without departing from the scope of the invention.

Advertiser 315 may subsequently register the advertising content with clearinghouse 340, and the content may be ingested (e.g., stored in a repository) by clearinghouse 340, distributor 320, and/or player 380 upon clearinghouse 340 determining that the advertising content complies with content delivery model 200. Accordingly, clearinghouse 340, distributors 320, and/or players 380 may receive (i.e., ingest) one or more insertable advertisements, which uniquely identify advertisers 315 associated with the insertable advertisements. In some implementations, advertisers 315 (or others) may establish billing preferences for various circumstances.

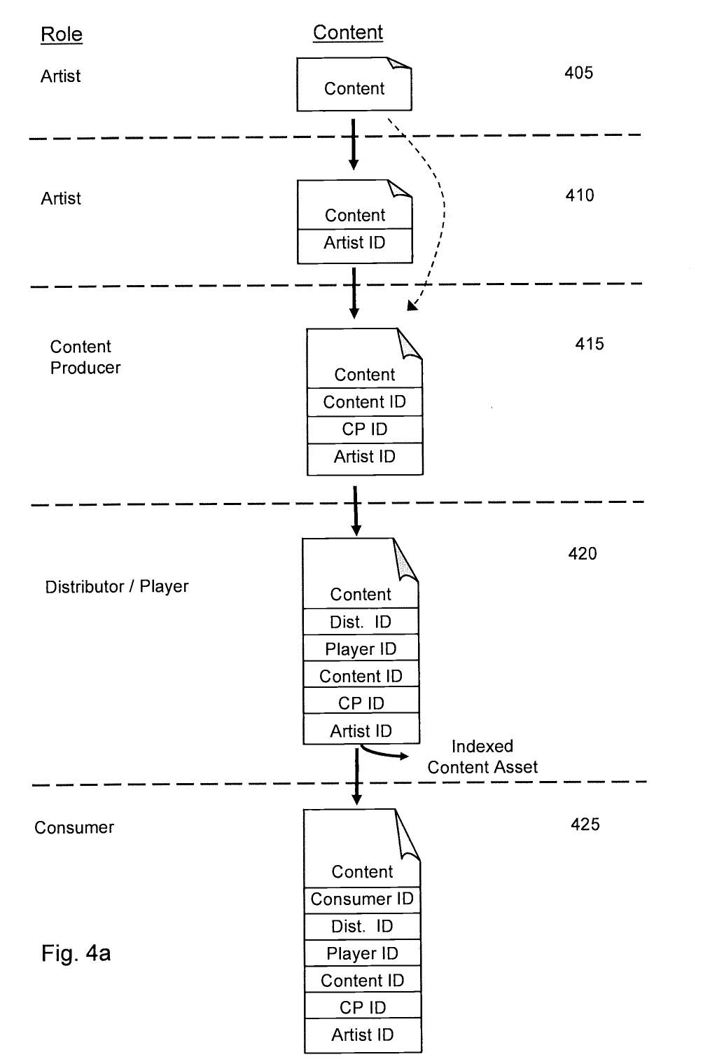

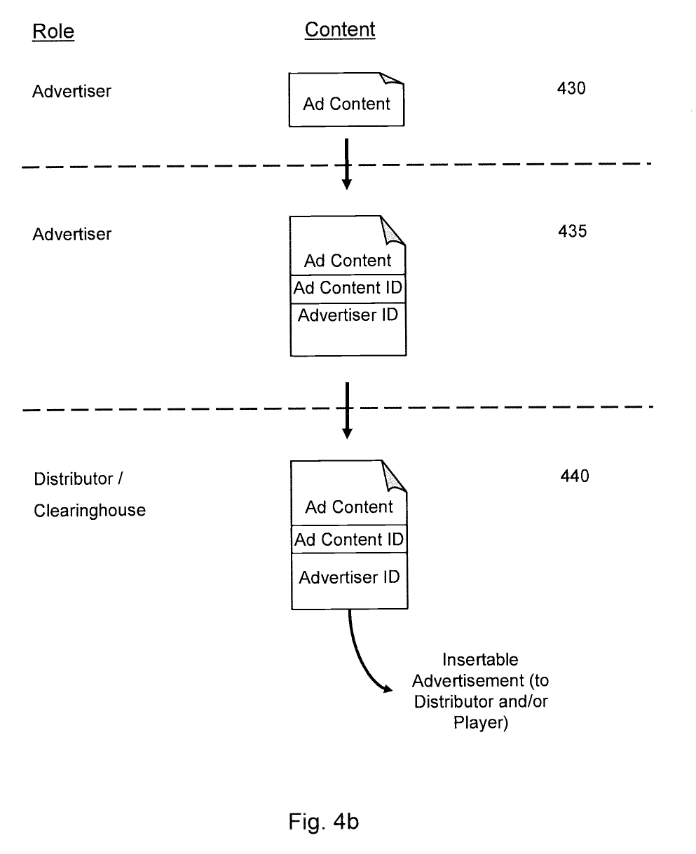

Content (e.g., media, advertising, or other content) may be created in compliance with content delivery model 200 as described above in FIG. 3b. That is, artists 305, content producers 310, distributors 320, players 380, and/or clearinghouse 340 may collectively create one or more indexed content assets, and advertisers 315, distributors 320, players 380, and/or clearinghouse 340 may collectively create one or more insertable advertisements. FIGS. 4a-b illustrate exemplary states of content created according to the techniques described in FIG. 3b.

As shown in FIG. 4a, content creation may begin when an artist creates a piece of content in an operation 405. Artist-created content may include audio works, video works, authored articles, or other forms of content that would be apparent to those skilled in the art. In an operation 410, the artist may encode the content in accordance with content delivery model 200, and content metadata may be imprinted with the artist's unique identifier, along with other description information as described above. In some implementations, operation 410 may optionally be bypassed (e.g., via the dashed line), and artist-created content may be provided directly to a content producer in an operation 415. When operation 410 is bypassed, the content producer may encode the content in accordance with content delivery model 200, and content metadata may be imprinted with the artist's unique identifier, the content producer's unique identifier, along with other description information as described above.

The content producer may register the content with a clearinghouse, and the clearinghouse may validate the content for compliance with content delivery model 200. When the content is validated, the clearinghouse may extract metadata description information about the content, assign a unique identifier to the content, and store the unique identifier and other information about the content. The clearinghouse may provide the unique identifier for the content to the content producer, and the content producer may imprint the content metadata with the unique identifier in operation 415. Subsequently, the content producer may provide the content to a distributor, a player, and/or the clearinghouse in an operation 420. The distributor and/or the player may imprint the content metadata with their respective unique identifiers in operation 420. The content may then be an indexed content asset that has content licensing platform 245 embedded therein, wherein the indexed content asset may be maintained by the distributor, the player, and/or the clearinghouse for further action.

Subsequently, in an operation 425, once the indexed content asset has been provided to a consumer, the consumer may share or otherwise transfer the content asset to another consumer. The metadata of the transferred content asset may be imprinted with a unique identifier of a consumer who most recently received the content directly from a distributor. Operation 425 may be used to trace the origin and use of content items across distinct systems used by various artists, content producers, distributors, advertisers, and consumers spread across unlimited locations. In some implementations, when consumers share content in a peer-to-peer fashion, metadata identifiers associated with a first distributor and/or player through which the content arrived to a first consumer may be substituted by metadata identifiers associated with a second distributor and/or player of a second consumer's choice. Compensation for playback/use of the content will be granted to all entities in a direct path between the consumers and the proper artists based on which respective player/distributor the consumer decides to use. In some implementations, monetary incentives may exist to reward consumers, distributors, and/or others whose identifiers are most diffused across an entire population of consumers.

As shown in FIG. 4b, advertising content creation may begin when an advertiser creates a piece of advertising content in an operation 430. Advertising content may include audio advertisements, video advertisements, image-based advertisements, text advertising, or other forms of advertising content that would be apparent to those skilled in the art. In an operation 435, the advertiser may encode the content in accordance with content delivery model 200, and advertising content metadata may be imprinted with the advertiser's unique identifier, along with other description information as described above. The advertiser may register the advertising content with the clearinghouse, which may validate the advertising content for compliance with content delivery model 200. When the advertising content is validated, the clearinghouse may extract metadata description information about the advertising content, assign a unique identifier to the advertising content, and store the unique identifier and other information about the advertising content in a repository. The clearinghouse may provide the unique identifier for the advertising content to the advertiser, and the advertiser may imprint the content metadata with the unique identifier in operation 435. Subsequently, the advertiser may provide the advertising content to the distributor and/or the clearinghouse in an operation 440. The advertising content may then be an insertable advertisement that has content licensing platform 245 embedded therein. The insertable advertisement may be maintained in a repository by the distributor and/or the clearinghouse for further action (e.g., for providing the advertisement to a player for insertion into content).

Referring to FIG. 3c, an exemplary content delivery data flow is provided according to various aspects of the invention. The content delivery data flow may include a distributor 320, player 380, and/or a clearinghouse 320 providing advertisement-supported content to one or more consumers 375a, 375b, etc. For example, as described above, distributor 320 and/or clearinghouse 340 may store one or more indexed content assets, along with identifiers and/or metadata for the indexed content assets, in respective repositories (e.g., in a dynamic metadata database). Further, in some implementations, distributor 320, player 380, and/or clearinghouse 340 may store one or more insertable advertisements, along with identifiers and/or metadata for the insertable advertisements, in an advertisement repository. Thus, according to various aspects of the invention, advertisement-supported content may be delivered to consumers 375 to maximize revenue for every content asset transaction.

A distributor 320, player 380, and/or consumer 375a may provide delivered indexed content assets to other consumers 375b using any suitable technique known to those skilled in the art (e.g., via peer-to-peer sharing, a data stream, download, etc.). In some implementations, distributor 320 may imprint the indexed content asset's metadata with a unique identifier for distributor 320 before distributing the content to consumer 375a (e.g., via player 380). The indexed content asset may be embedded with content licensing platform 245, which may specify a pricing scheme for the content asset. For example, artists, content producers, or others may specify a minimum price for distribution of the content asset. Consumer 375a may use any suitable hardware and/or software platforms to access the content asset. For example, consumer 375a may use a media player 380 compliant with content licensing platform 245 (e.g., via a plug-in, an application provided by distributor 320, or any other application compliant with content licensing platform 245). Accordingly, the compliant hardware and/or software platform may extract information from the content asset (e.g., a codec, content licensing platform, etc.). For example, the extracted information may include information about the content asset (e.g., using associated metadata), consumer 375a (e.g., via a consumer information provider), or other information may be extracted. The information may be received by distributor 320 (e.g., by tracking module 135 shown in FIG. 1).

After distributor 320 receives information about consumer 375a, the content asset being consumed, and/or the other information, distributor 320 and clearinghouse 340 may collectively process the information to determine an appropriate insertable advertisement for insertion in the content asset. For example, distributor 320 and/or player 380 may send the information to clearinghouse 340, and clearinghouse 340, distributor 320, and/or player 380 may collectively use one or more business intelligence modules to determine which advertisement to insert (e.g., based on maximum revenue generated from insertion).

The business intelligence modules may correlate information about the content asset (e.g., via content metadata), various available advertisements (e.g., via advertisement metadata), and/or consumers (e.g., via a consumer information provider). Accordingly, the business intelligence modules may perform various search and/or discovery tasks to dynamically match advertisers to consumers 375a, 375b, etc. on a one-to-one basis. By having a repository of unique identifiers and/or dynamic metadata for each content asset and/or insertable advertisement, content owners may be assured that each content asset will be matched to a highest bidding advertiser for a given consumer. Furthermore, advertisers may be assured that a likely purchaser of their products and/or services may be reached through ad-insertion into the given consumer's content, and therefore, advertisers may be willing to pay premiums for specific audience impressions.

Moreover, tracking capabilities embedded within content assets and/or advertisements justifies costs of ad-insertion, as the tracking capabilities may demonstrate whether or not an advertising impression occurred, who received the impression, or other information. Further, content assets may include various encoding enhancements, such as time-stamps indicating location breaks for advertisement insertion. Thus, ad-insertion need not be restricted to “bumper ads,” which are inserted before and/or after content endpoints, but rather, advertisements may be inserted in various places within the content. For example, the insertion points may be locations deemed appropriate placeholders for advertising (e.g., by content creators). For example, an artist or content producer creating a radio podcast may go to a commercial break during a local broadcast, and the created radio podcast content may be encoded with information indicating the commercial break as an appropriate place to insert an advertisement. Accordingly, more advertisements may be inserted into content, and value of a content asset may be maximized throughout the content's duration.

After the business intelligence modules selects advertisements to insert into the content asset, distributor 320 and/or clearinghouse 340 may send the insertable advertisements to consumer 375a. Accordingly, the selected insertable advertisements may ensure content owners receive a certain amount of revenue from a content asset transaction. However, in some implementations, consumer 375a may be unwilling to receive content including advertising. Therefore, content licensing platform 245 may implement a variable pricing scheme, which enables consumers 375a, 375b, etc. to establish a price for the content asset. For example, various options may be provided (e.g., via an interface of player 380) to enable consumers 375a, 375b, etc. to specify a willingness to pay for content, a willingness to listen to advertisements, or various combinations thereof.

For example, an amount and/or a relatedness of advertising provided may be increased or decreased in accordance with the specified information. That is, consumers 37a, 375b, etc. increase their willingness to pay, the amount (e.g., a percentage) and/or relatedness of advertising inserted into content may decrease, whereas when consumers 375a, 375b, etc. decrease their willingness to pay (or indicate they wish to pay nothing at all), the amount and/or relatedness of advertising may increase. Accordingly, a content asset transaction may generate revenue in an amount neutral to consumer willingness to pay, because an amount paid by consumers 375a, 375b, etc. may be supplemented by payments by advertiser 315. For example, when advertisements selected for insertion total revenue of $2.00, the content asset transaction may generate at least $2.00 regardless of payments received from consumer 375. For example, consumers 375a, 375b, etc. may elect to pay $2.00 to receive advertisement-free content, or consumers 375a, 375b, etc. may elect to pay nothing for content having a maximum number and/or optimally related advertisements.

Consumers 375a, 375b, etc. may be directed to a distributor of their choice, or to clearinghouse 340, to pay for the license, and the content may be freed of restrictions to play advertisements. In another example, content encoded with a “do not share,” or other copy-protection mechanism, may be shareable by encoding the content with content licensing platform 245. That is, metadata may be associated with the content that sharing by indicating that such content requires advertisement-insertion during playback. Accordingly, advertisers may pay for insertion into previously copy-protected content, such that proper royalties may be paid to owner(s) of the content.

In similar fashion as described above, consumer 375b may receive content using any suitable transfer technique, such as peer-to-peer, file transfer protocol, etc., to access content. Consumer 375b may use any compliant hardware and/or software platforms to play the content, wherein consumer 375b need not necessarily be affiliated with clearinghouse 340, distributor, etc. Provided that consumer 375b uses a hardware and/or software platform in compliance with content licensing platform 245, the compliant hardware and/or software may extract consumption information when consumer 375b uses, views, listens to, or otherwise consumes the content. Further, the compliant hardware and/or software may automatically communicate with clearinghouse 340, or one or more distributors 320, to determine advertisement insertion. Accordingly, the compliant hardware and/or software platform(s) may extract information from content licensing platform 245 embedded therein to handle paying content owners, billing advertisers or consumers, or performing other tasks enabled by content licensing platform 245. As such, consumers may be free to receive content from their preferred source, and content licensing platform 245 may automatically handle rights management for various entities in the transaction chain.

Referring to FIG. 3d, an exemplary content tracking data flow is provided according to various aspects of the invention. The content tracking data flow may include information being provided from a consumer 375a and/or player 380 to a distributor 320, wherein distributor 320, and/or player 380 communicates the tracking information to a clearinghouse 340. For example, consumer 375a may use any suitable hardware and/or software platforms to extract a codec, content metadata, advertisement metadata, consumer information, or other information from content having content licensing platform 245 embedded therein. For instance, the content may include an indexed content asset having advertising content inserted therein. Therefore, the hardware and/or software platforms may provide to distributor 320 and/or player 330 extracted information about content consumption (e.g., via a content identifier), advertising consumption (e.g., via an advertisement identifier), or other information. Distributor 320 and/or player 380 may relay the information to clearinghouse 340, which may track, validate, audit, and otherwise process the information. In another example, a consumer 375b may receive content from other consumers 375a, or in other ways, and a compliant hardware and/or software platform may communicate consumption information to a distributor 320 associated with consumer 375b, or the consumption information may be provided directly to clearinghouse 340, or in other ways. Accordingly, consumption information may be used for billing, royalty payments, profile building, or in other ways, regardless of how content was provided to an end user.

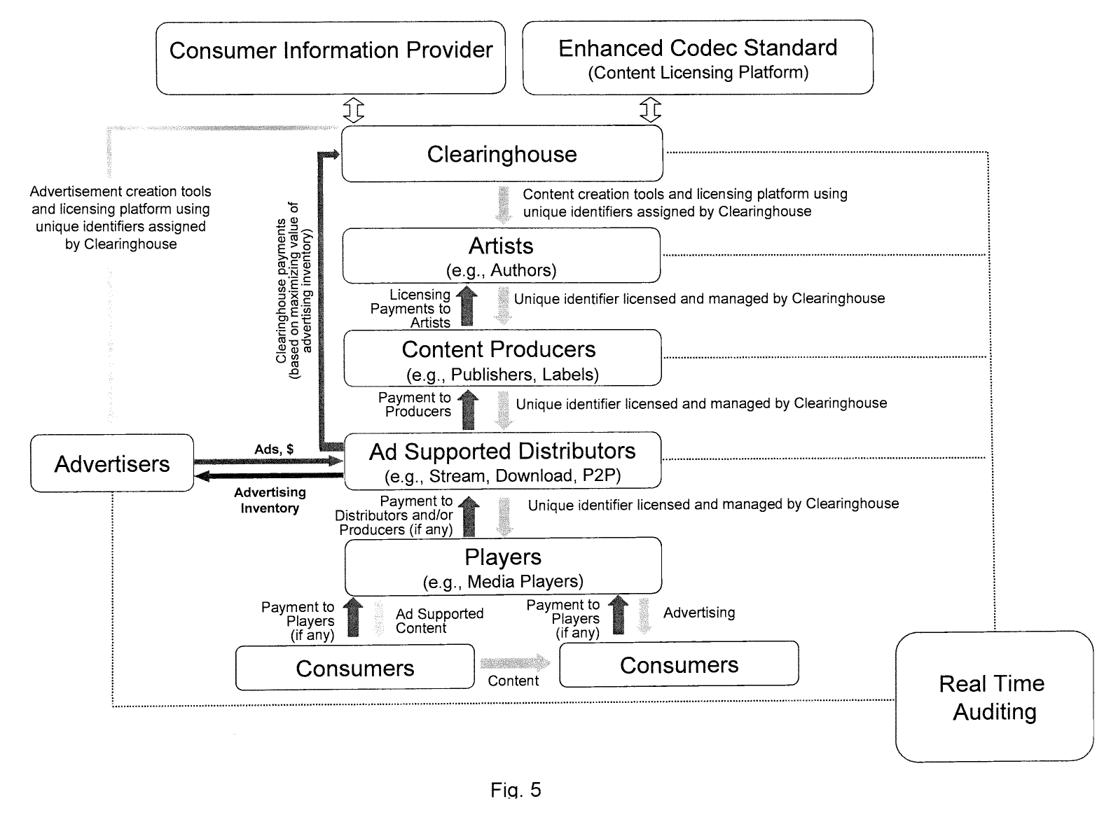

Referring to FIG. 5, an exemplary content asset transaction chain is illustrated according to various aspects of the invention. The content asset transaction chain may be centered on a clearinghouse, which manages an enhanced codec standard that includes a content licensing platform. The clearinghouse may provide various tools for authors, content producers, distributors, advertisers or others to create content and/or advertising on the content licensing platform. Furthermore, the clearinghouse may provide unique identifiers to each entity in the transaction chain to identify entities associated with consumed content, advertising, etc. Advertisers may pay distributors and/or the clearinghouse to have advertisements inserted into content, where the advertisements and the content both may be created using the content licensing platform. Accordingly, consumers may receive advertising supported content that may be consumed using players of the consumers' choice. Moreover, consumers may receive content from a distributor of their choice, such that distributors may have flexibility to determine payment schedules for their consumers. As such, the consumers' distributors may handle privacy issues and protection of personal consumer data. By having the clearinghouse manage a relationship with distributors, a payment methodology may protect rights of authors, content producers, distributors, advertisers, and/or others having rights to content, while insulating consumers from many of the formalities associated therewith. Therefore, each entity in the chain may receive maximum value from a content asset transaction using a centralized transaction management system according to various aspects of the invention.

Implementations of the invention may be made in hardware, firmware, software, or any combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, those skilled in the art will recognize that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it is understood that it is within the knowledge of one skilled in the art to effect such feature, structure, or characteristic in connection with other aspects or implementations whether or not explicitly described. Thus, various changes and modifications may be made, without departing from the scope and spirit of the invention. The specification and drawings are to be regarded as exemplary only, and the scope of the invention is to be determined solely by the appended claims.

What is claimed is:

1. A method for managing content transactions using a clearinghouse, the clearinghouse including at least one repository storing at least one advertisement profile, the method comprising:
building at least one consumer profile, the consumer profile describing a consumer requesting content;
selecting at least one advertisement for insertion into the requested content, the selecting based on a correlation of the consumer profile, the advertisement profile, and a content profile associated with the requested content, the content profile identifying at least one entity having rights to the requested content; and
generating payment information for the at least one entity when the requested content is consumed.

2. The method of claim 1, wherein the content profile is associated with content created using a content licensing platform, and wherein the advertisement profile is associated with an advertisement created using the content licensing platform.

3. The method of claim 2, wherein the content licensing platform enables entities having rights to content to specify a pricing scheme for the content.

4. The method of claim 2, wherein the content licensing platform enables advertisers to specify a bidding scheme for paying for advertisement insertion.

5. The method of claim 2, wherein the content licensing platform enables consumers to specify a price for content.

6. The method of claim 5, wherein a number and/or a relatedness of advertisements selected for insertion is varied according to the specified price.

7. The method of claim 2, wherein the content licensing platform enables advertisement insertion based on commercial time stamps embedded within content created using the content licensing platform.

8. The method of claim 1, further comprising assigning a unique identifier to at least one artist, at least one content producer, at least one distributor, at least one advertiser, and/or at least one consumer.

9. The method of claim 8, wherein the unique identifiers are used to generate the payment information.

10. The method of claim 8, further comprising:
inserting the selected advertisement into the requested content; and
generating billing information for at least one advertiser associated with the selected advertisement when the selected advertisement is consumed, wherein the unique identifiers are used to generate the billing information.

11. The method of claim 2, wherein the content licensing platform includes a codec metadata for providing descriptive information about content created using the content licensing platform.

12. The method of claim 2, wherein the content licensing platform includes a codec metadata for providing descriptive information about a target audience of an advertisement created using the content licensing platform.

13. The method of claim 2, wherein the content licensing platform enables legal peer-to-peer distribution of content created using the content licensing platform.

14. The method of claim 2, wherein the content licensing platform enables a first consumer to pay a first price for requested content, and a second consumer to pay a second price for the requested content, wherein the second consumer receives the requested content from the first consumer using a peer-to-peer mechanism and the second price is different from the first price.

15. The method of claim 1, further comprising tracking consumption information for the requested content and/or the selected advertisement, wherein the tracking is neutral to a source of the content.

16. The method of claim 15, the tracked consumption information including real-time transaction data, the method further comprising providing the real-time transaction data to a requesting entity.

17. A system for managing content transactions, the system comprising a clearinghouse and at least one repository, the at least one repository storing at least one advertisement profile, the system further comprising a computer-readable medium having computer-executable instructions embodied therein, the computer-executable instructions operable when executed to:
build at least one consumer profile, the at least one consumer profile describing a consumer requesting content;
select at least one advertisement for insertion into the requested content, the selecting based on a correlation of the consumer profile, the advertisement profile, and a content profile associated with the requested content, the content profile identifying at least one entity having rights to the requested content; and
generate payment information for the at least one entity when the requested content is consumed.

18. The system of claim 17, wherein the content profile is associated with content created using a content licensing platform, and wherein the advertisement profile is associated with an advertisement created using the content licensing platform.

19. The system of claim 18, wherein the content licensing platform enables entities having rights to content to specify a pricing scheme for the content.

20. The system of claim 18, wherein the content licensing platform enables advertisers to specify a bidding scheme for paying for advertisement insertion.

21. The system of claim 18, wherein the content licensing platform enables consumers to specify a price for content.

22. The system of claim 21, wherein a number and/or a relatedness of advertisements selected for insertion is varied according to the specified price.

23. The system of claim 18, wherein the content licensing platform enables advertisement insertion based on commercial time stamps embedded within content created using the content licensing platform.

24. The system of claim 17, the computer-executable instructions further operable when executed to assign a unique identifier to at least one artist, at least one content producer, at least one distributor, at least one advertiser, and/or at least one consumer.

25. The system of claim 24, wherein the unique identifiers are used to generate the payment information.

26. The system of claim 24, the computer-executable instructions further operable when executed to:
insert the selected advertisement into the requested content; and
generate billing information for at least one advertiser associated with the selected advertisement when the selected advertisement is consumed, wherein the unique identifiers are used to generate the billing information.

27. The system of claim 18, wherein the content licensing platform includes a codec metadata for providing descriptive information about content created using the content licensing platform.

28. The system of claim 18, wherein the content licensing platform includes a codec metadata for providing descriptive information about a target audience of an advertisement created using the content licensing platform.

29. The system of claim 18, wherein the content licensing platform enables legal peer-to-peer distribution of content created using the content licensing platform.

30. The system of claim 18, wherein the content licensing platform enables a first consumer to pay a first price for requested content, and a second consumer to pay a second price for the requested content, wherein the second consumer receives the requested content from the first consumer using a peer-to-peer mechanism and the second price is different from the first price.

31. The system of claim 17, the computer-executable instructions further operable when executed to track consumption information for the requested content and/or the selected advertisement, wherein the tracking is neutral to a source of the content.

32. The system of claim 31, the tracked consumption information including real-time transaction data, the computer-executable instructions further operable when executed to provide the real-time transaction data to a requesting entity.
